(19) United States
(12) Patent Application Publication
(10) Pub. No.: US 2015/0165617 A1
(43) Pub. Date: Jun. 18, 2015

(54) PROTECTION DEVICE FOR TOOL BOX

(71) Applicant: Shwu-Ruu Chern, Taichung (TW)

(72) Inventor: Shwu-Ruu Chern, Taichung (TW)

(21) Appl. No.: 14/109,991

(22) Filed: Dec. 18, 2013

(51) Int. Cl. B25H 3/02

(52) U.S. Cl. CPC B25H 3/02

(57) ABSTRACT

A tool box includes two parts which are connected to each other. Each part has a cross-shaped first recessed area on the outer surface thereof. Three second recessed areas are respectively defined in the two sides and the underside of each of the two parts. Each of the two parts has four corner portions formed on four corners thereof A first protection plate is connected to the first recessed area of one of the two parts. Each of the second recessed areas of each of the two parts has a second protection plate connected thereto. The first and second protection plates are made by metal so as to protect the tool box.

### BACKGROUND OF THE INVENTION

1. Fields of the Invention

The present invention relates to a tool box, and more particularly, to a tool box with metal protection plates connected to the outside thereof.

2. Descriptions of Related Art

The conventional tool box 40 is disclosed in FIG. 6 and generally comprises a cover 41 and a base 42 on which the cover 41 is mounted. The conventional tool box 40 is made by metal which is heavy and difficult to be machined. In order to improve the problems mentioned above, the modem tool box is made by plastic such as ABS which is easily machined, light and involves less number of manufacturing steps. Besides, the plastic is anti-rust and anti-corrosive so that the plastic replaces the metal to be the main material for the tool boxes.

However, the plastic tool box is easily scrubbed by the tools and scratches are left in surface of the tool box. These scratches easily catch oil, grease and debris which affect the appearance of the tool box.

When in use, the base 42 of the tool box 40 is usually put on the ground and the cover 41 is opened as shown in FIG. 7 to pick the tools out from the tool box. Because the surface of each of the cover 41 and the base 42 is a flat surface which is direction in contact with the ground so as to have the scratches mentioned above.

The present invention intends to provide a protection device for a tool box to improve the shortcomings mentioned above.

### SUMMARY OF THE INVENTION

The present invention relates to a tool box and comprises two parts which are connected to each other. Each part has a cross-shaped first recessed area on the outer surface thereof. Three second recessed areas are respectively defined in the two sides and the underside of each of the two parts. Each of the two parts has four corner portions formed on four corners thereof. A first protection plate is connected to the first recessed area of one of the two parts. Each of the second recessed areas of each of the two parts has a second protection plate connected thereto.

Preferably, each of the first and second protection plates is made by metal.

Preferably, the two sides and the underside of each of the two parts has a first slit. Each of the first slits has a first hook formed therein. Each of the second protection plates has two second hooks extending from two sides thereof. The second hooks of the second protection plates are hooked with the first slits and the first hooks.

Preferably, the each of the first recessed areas has multiple second slits. Each of the first protection plates has two insertions on two sides thereof, and the insertions are engaged with the second slits.

Preferably, the each of the first protection plates has patterns graved or printed thereon.

The primary object of the present invention is to provide a tool box which has limited area to be in contact with the ground directly.

Another object of the present invention is to provide a tool box with metal protection plates connected to the outer surface so as to protect the tool box from being scratched.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tool box of the present invention;

FIG. 2 is an exploded view of the tool box of the present invention;

FIG. 3 is an exploded view to show one of the two parts and the protection plates of the tool box of the present invention;

FIG. 4 is a cross sectional view of the tool box of the present invention;

FIG. 5 shows that the tool box of the present invention is put on the ground;

FIG. 6 is a perspective view to show the conventional tool box, and

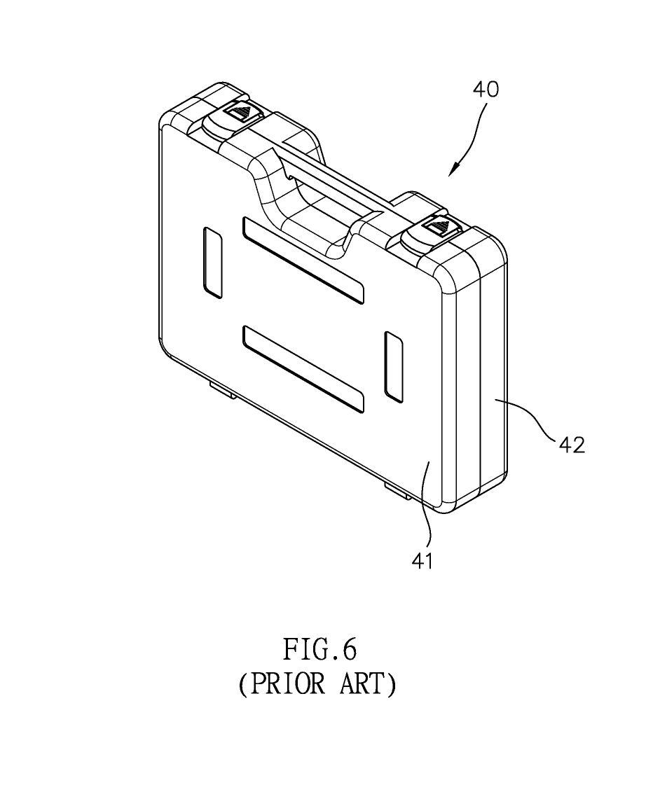

FIG. 7 shows that the conventional tool box is put on the ground.

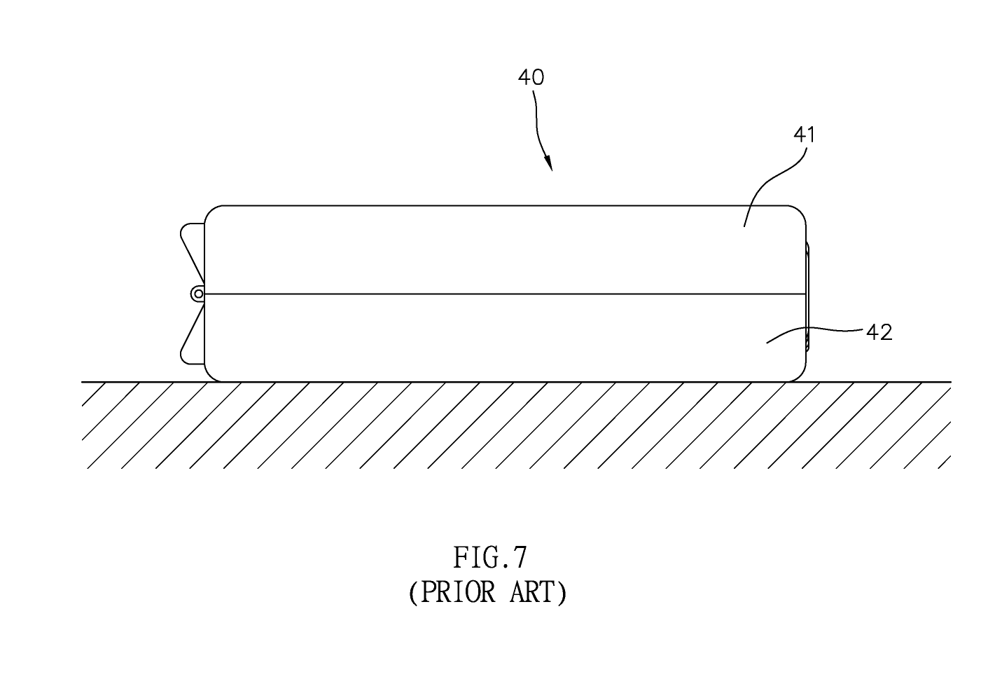

### DETAILED DESCRIPTION OF THE PREFERRED EMBODIMENT

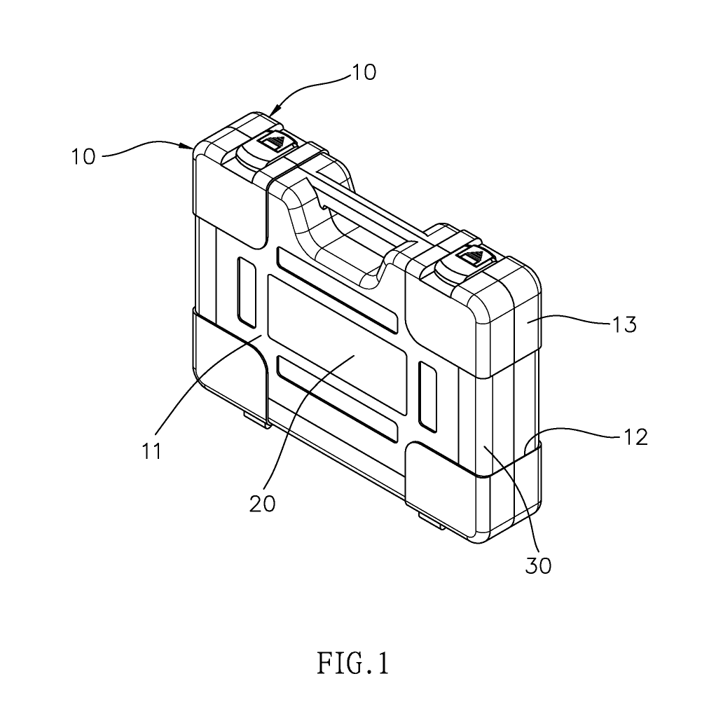

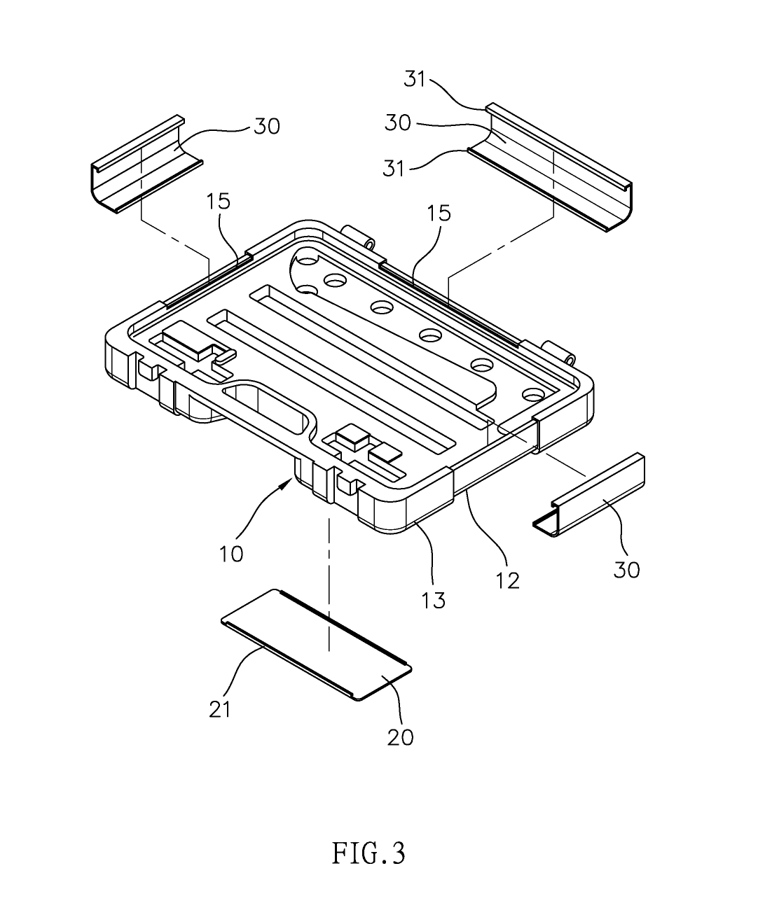

Referring to FIGS. 1 to 5, the tool box of the present invention comprises two parts 10 which are pivotably connected to each other. Each part 10 has a cross-shaped first recessed area 11 on the outer surface thereof, and three second recessed areas 12 are respectively defined in two sides and an underside of each of the two parts 10. Each of the two parts 10 has four corner portions 13 formed on four corners thereof. The four corner portions 13 protrude out from each of the two parts 10 when compared with the first and second recessed areas 11, 12. A first protection plate 20 is connected to the first recessed area 11 of one of the two parts 10. Each of the second recessed areas 12 of each of the two parts 10 has a second protection plate 30 connected thereto. Each of the first and second protection plates 20, 30 is made by metal.

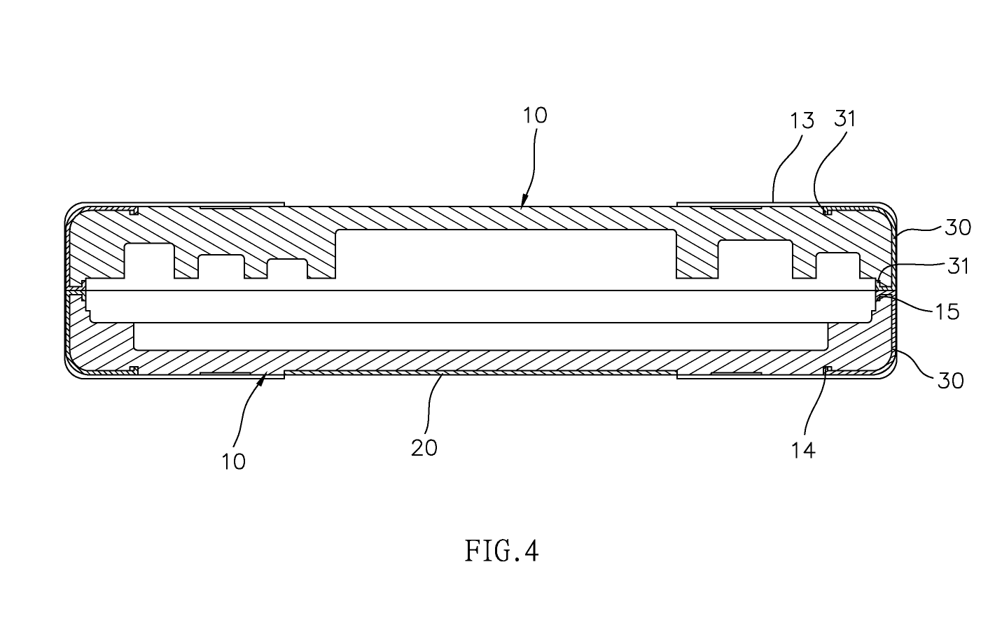

The two sides and the underside of each of the two parts 10 has a first slit 14, and each of the first slits 14 has a first hook 15 formed therein. Each of the second protection plates 30 has two second hooks 31 respectively extending from two sides thereof. The second hooks 31 of the second protection plates 30 are hooked with the first slits 14 and the first hooks 15 as shown in FIG. 4.

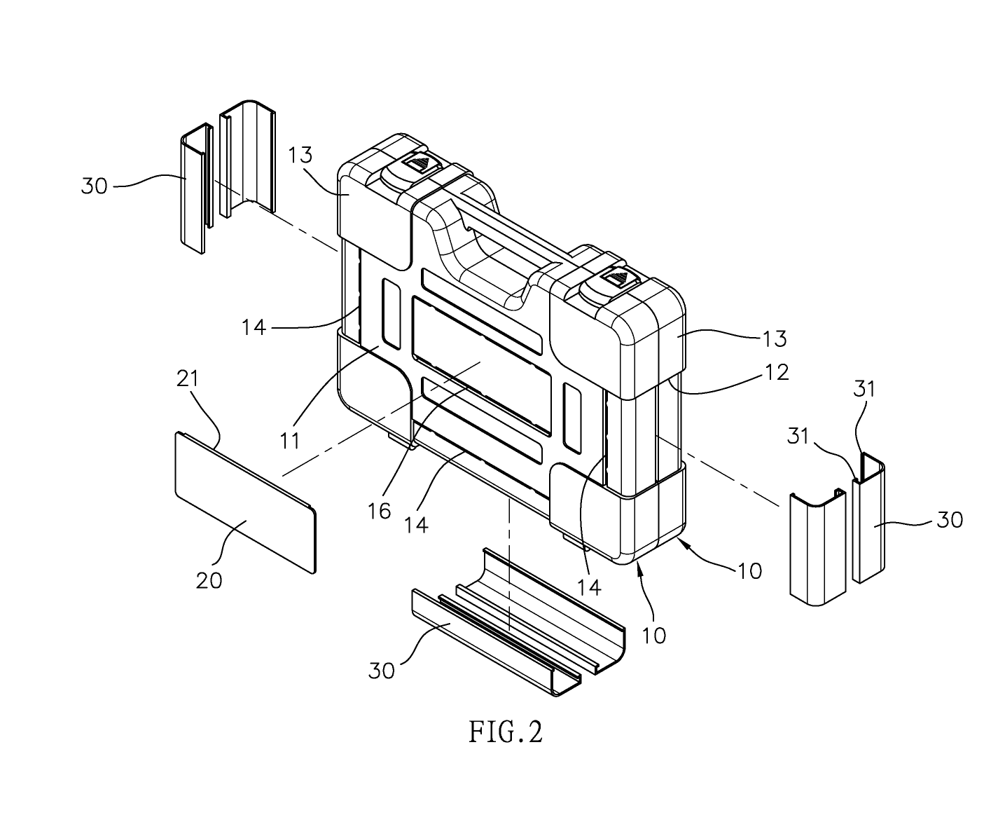

Each of the first recessed areas 11 has multiple second slits 16. Each of the first protection plates 20 has two insertions 21 on two sides thereof, and the insertions 21 are engaged with the second slits 16 as shown in FIG. 2. Each of the first protection plates 20 has patterns graved or printed thereon. The tool box may have holding units (not shown) installed thereto so as to hold tools in the tool box.

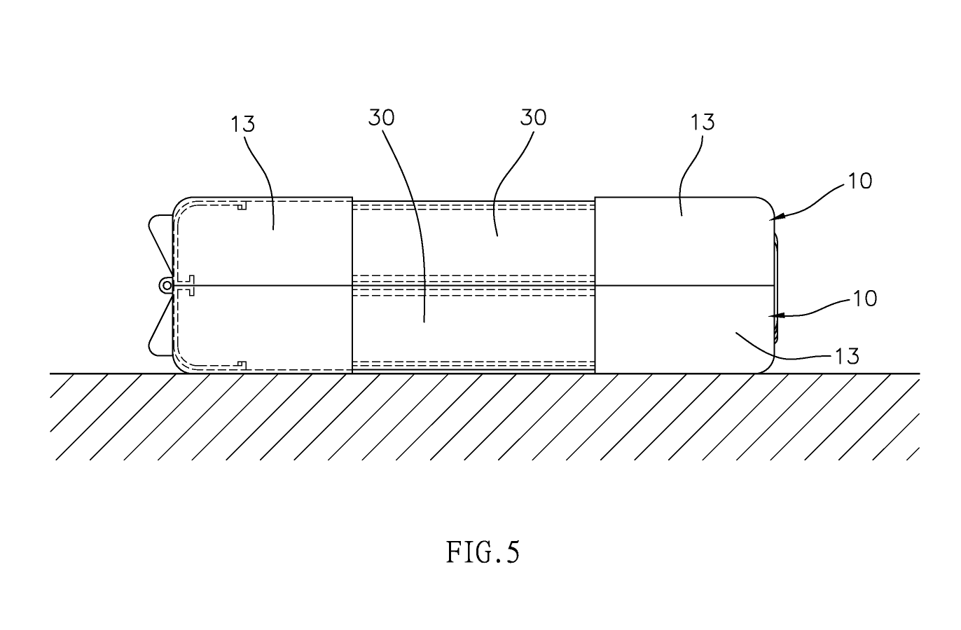

Referring to FIG. 5, when the tool box is put on the ground, only the four protruded corner members 13 are in contact with the ground, so that the tool box does not scratched by the rough ground.

The first and second protection plates 20, 30 are made by metal so as to protect the outside of the tool box. When the first and second protection plates 20, 30 are scratched, they can be easily replaced with new ones to keep the tool box neat and clean.

While we have shown and described the embodiment in accordance with the present invention, it should be clear to those skilled in the art that further embodiments may be made without departing from the scope of the present invention.

What is claimed is:

1. A tool box comprising:
two parts which are connected to each other, each part having a cross-shaped first recessed area on an outer surface thereof, three second recessed areas respectively defined in two sides and an underside of each of the two parts, each of the two parts having four corner portions formed on four corners thereof, a first protection plate connected to the first recessed area of one of the two parts, each of the second recessed areas of each of the two parts having a second protection plate connected thereto.

2. The tool box as claimed in claim 1, wherein each of the first and second protection plates is made by metal.

3. The tool box as claimed, in claim 1, wherein the two sides and the underside of each of the two parts has a first slit, each of the first slits has a first hook formed therein, each of the second protection plates has two second hooks extending from two sides thereof, the second hooks of the second protection plates are hooked with the first slits and the first hooks.

4. The tool box as claimed in claim 1, wherein each of the first recessed areas has multiple second slits, each of the first protection plates has two insertions on two sides thereof, the insertions are engaged with the second slits.

5. The tool box as claimed in claim 1, wherein each of the first protection plates has patterns graved or printed thereon.
